(19) United States
(12) Patent Application Publication
(10) Pub. No.: US 2002/0067504 A1
(43) Pub. Date: Jun. 6, 2002

(54) Method and apparatus for automatic upgrade of a product's printer driver

(75) Inventors: David Salgado, Victor, NY (US); Srinivasa Murthy, Bellevue, WA (US)

Correspondence Address: Albert P. Sharpe, III, Esq., Fay, Sharpe, Fagan, Minnich & McKee, LLP, 1100 Superior Avenue, 7th Floor, Cleveland, OH, 44114-2518, US

(73) Assignee: XEROX CORPORATION

(21) Appl. No.: 09/731,094

(22) Filed: Dec. 6, 2000

(51) Int. Cl. G06K 15/02; G06F 3/12; G06F 9/445; G06F 13/00

(52) U.S. Cl. 358/1.15; 717/171

(57) ABSTRACT

A method and apparatus for automatically updating a printer driver on a computer. At a designated time or upon a designated event, a program subroutine searches for an updated version of a resident printer driver at a specified remote location. If an updated version is found, the new version is downloaded to the computer and installed. The old version is uninstalled. The subroutine performing the update process may be associated with a printer driver or part of a separate install/upgrade program. The level of user interaction in the upgrade process can be adjusted to fit the preferences of the user.

### BACKGROUND OF THE INVENTION

1. Field of the Invention

The present invention pertains to a computer system and/or software, particularly a system and/or software for updating printer drivers. More particularly, the present invention relates to a method and apparatus for automatically updating a printer driver located on a host computer by accessing and downloading the updated driver from a remote network site.

2. Discussion of the Art

Printers are common peripheral devices attached to computers. A printer allows a computer user to make a hard copy of documents that are created in a variety of applications and programs on a computer. To function properly, a channel of communication is established between the printer and the computer to enable the printer to receive commands and information from the host computer. Common ways of accomplishing this are through the use of a connective cable directly between the printer and a port on the host computer or through a network connection.

Once a connection is established between the workstation and the printer, the document to be printed is translated into a format that the printer recognizes. To accomplish this, software is loaded onto the host computer that converts code representing a document to be printed into a format that the printer can understand. This software is referred to as a printer driver. Two elements of the printer driver are a user interface, and a Page Description Language (“PDL”) encoder. The user interface is a graphical interface feature of the printer driver that permits customization of a print job. It allows the user to control the printing output, such as which pages to print and the number of copies. The PDL encoder is computer code that takes the document and converts it into printer ready format by encoding the document into a PDL language that the printer understands. Each model of printer has its own printer driver. In addition, different computers may have different printer drivers depending on the software that is used on that particular computer. Thus, two computers on the same network using the same network printer may have different printer drivers for that printer based on the operating system they utilize (e.g. Microsoft Windows, etc.), as well as the programs from which print jobs are generated. These various printer drivers are usually written and made available by the manufacturer of the printer they were designed for.

Periodically, printer drivers are updated by the printer manufacturers. This is done to correct errors in the previous printer driver, to add or modify features in the printing controls or to provide for changes in the operating system of the computer or its hardware. To take advantage of the features possessed by these updates, the user acquires the updated printer driver and installs it (replacing the existing one) on his or her computer. A user can perform the update by accessing a web site or other location on a network and downloading the new driver on to his or her computer. The driver is then installed and the old driver uninstalled from the computer.

Often however, a user may not become aware of the new updated driver. Even if the user does become aware of the new driver, he or she must manually access the update site and install the driver on his or her computer. This requires some level of technical computer savvy that not all users possess. If the user's computer is on a network controlled by a system administrator, the system administrator must install the new driver on each computer himself or give instructions to each user on how to perform this task. In either case, user action is required to update the printer driver. There is a possibility that some users may not acquire the new drivers and thus be deprived of the features that the new printer driver provides. Thus a need exists for a method and apparatus for automatically updating a printer driver with minimal or no user interaction.

### BRIEF SUMMARY OF THE INVENTION

In an exemplary embodiment of the invention, a printer driver for a printer contains an automatic upgrade feature that checks an update location for a newer version of the printer driver and upgrades to that version if it exists.

The printer driver can be programmed to check for updates of itself at certain times or upon the happening of certain designated events (e.g. once a week, upon startup, etc.). At the indicated time, the printer driver will contact a predetermined update site such as a web page or a location in a network server's memory. A hierarchy of update sites can be established, in which the printer driver will contact each site in turn until an updated version of itself is found.

Once the driver contacts the update site, it will search for any stored versions of itself at the site. If another printer driver is found, the searching driver will acquire the tagged information version control data from the new driver by querying the new driver and reading from its initialization file (e.g. “II file”). If the new driver is a more current version than the searching driver, the new driver will be downloaded onto the host computer. Once the new printer driver is downloaded, the old printer driver is uninstalled and the new printer driver is installed.

The level of automation at which these functions can be performed may be altered. Therefore, the driver can be set to query the user whether it should download and install a newer version once such a version is found. Alternately, the driver could be instructed to simply notify the user that a new driver has been successfully downloaded and installed.

Alternatively, instead of the printer driver performing the check for a newer version and upgrade, a separate install/upgrade application is used to perform the functions. This application performs the function for all printer drivers loaded on the user's computer. This application can be designed to run in a “background” mode without cessation of the computer or its programs. If the user attempts to print while an upgrade is in progress, a “please wait, upgrade in progress” message is presented to the user.

### BRIEF DESCRIPTION OF THE DRAWINGS

The following is a brief description of the drawings which are present for the purposes of illustrating the invention and not for purposes of limiting the same.

FIG. 1 is a diagram of a typical computer network with a connection to the Internet.

FIG. 2 is a diagram of a computer workstation with an attached printer and a connection to the Internet.

FIG. 3 is a diagram of a computer network in which updated drivers are stored in the memory of a network server.

FIG. 4 is a flowchart depicting the sequence of events carried out during the printer driver update process.

### DETAILED DESCRIPTION OF THE INVENTION

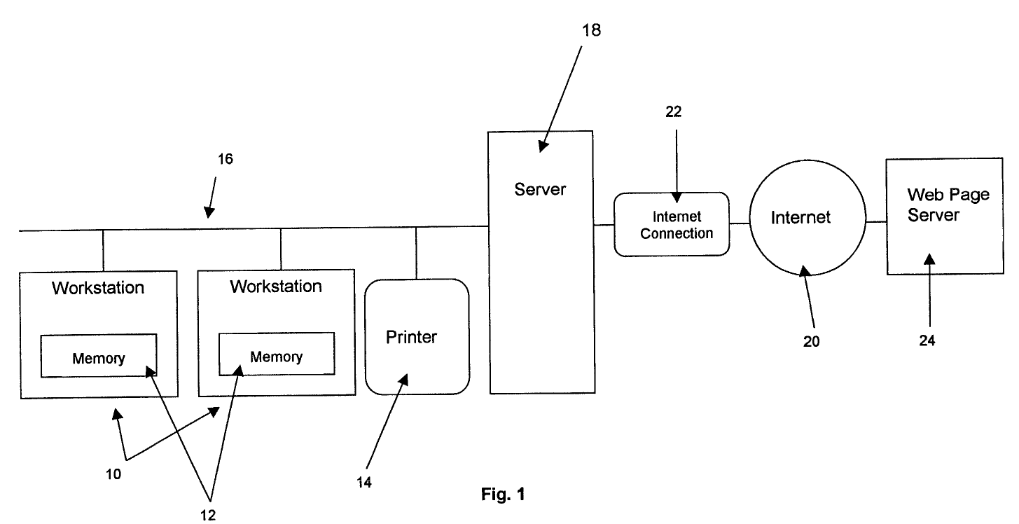

Referring to FIG. 1, a local area network (“LAN”) typical of one in which the present invention might be implemented is shown in which one or more individual workstation computers 10, each with a static memory module 12 such as a hard disk, and one or more network printers or multifunctional products having printing capabilities 14 are communicatively connected via a suitable communication channel 16, such as a coaxial cable or fiber-optic wire, to each other and one or more server computer 18. The server in turn may have a connection mechanism 20, such as a T1 line or modem for example, to communicate and exchange data with the Internet 22 or other external network.

It is to be understood that while the forgoing describes a hard wireline based system, both or one of the LAN network connections and the Internet connection to the LAN network may be achieved using wireless technology. It is also to be understood that the system printers 14 may be xerographic devices such that the system also operates in a xerographic environment.

Along with applications programs and operating system software, printer drivers for the network printers are stored in the static memory 12 of the individual workstations 10. Print jobs produced by the workstations are converted into printer ready format by the printer drivers and then sent to the designated network printer. Alternately, a separate print server may exist (not shown). In this configuration, all print jobs produced by the workstations are sent to the print server. There the jobs are routed to the designated printer.

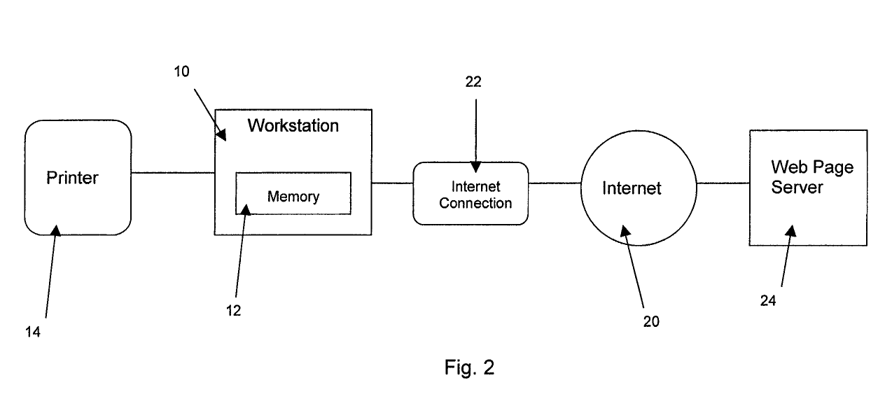

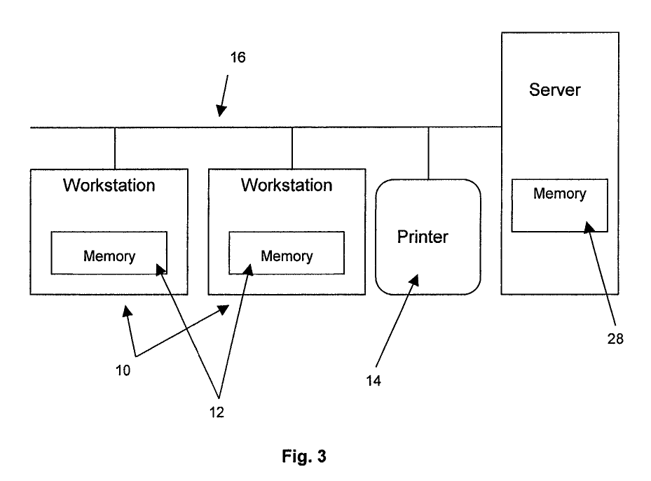

In another possible arrangement as shown in FIG. 2, the workstation 10 is a stand alone computer connected to a printer 14, without being part of a LAN. In this arrangement, the workstation needs some type of connection mechanism 22 with the Internet 20 or other external network. Such types of internet connection mechanisms are well known. Still another possible environment in which the invention may be inplemented is shown in FIG. 3. In this figure, the updated printer drivers are stored in the static memory 28 of the network server 18. This allows the system administrator to control which printer drivers are accessible to the workstations, and permits the system adminstrator to validate any printer drivers before they are made available.

On occasion, it might be desirable or necessary to update the resident printer drivers stored on a workstation. This may be due to an error discovered on the old printer driver or due to a change in the operating system environment in which a workstation is functioning. In accordance with this, the present invention provides for an automatic upgrading of printer drivers on a workstation. In one embodiment of the invention, each printer driver contains a program subroutine that will automatically attempt to update the resident printer driver on a workstation or print server at certain predetermined times or upon the occurrence of certain predetermined events. This program subroutine may be a software module associated with a printer driver or it may be part of a separate upgrade/install program. This update feature can be programmed to perform the update at certain intervals (e.g. once a week) or upon the occurrence of a stated event (e.g. upon startup).

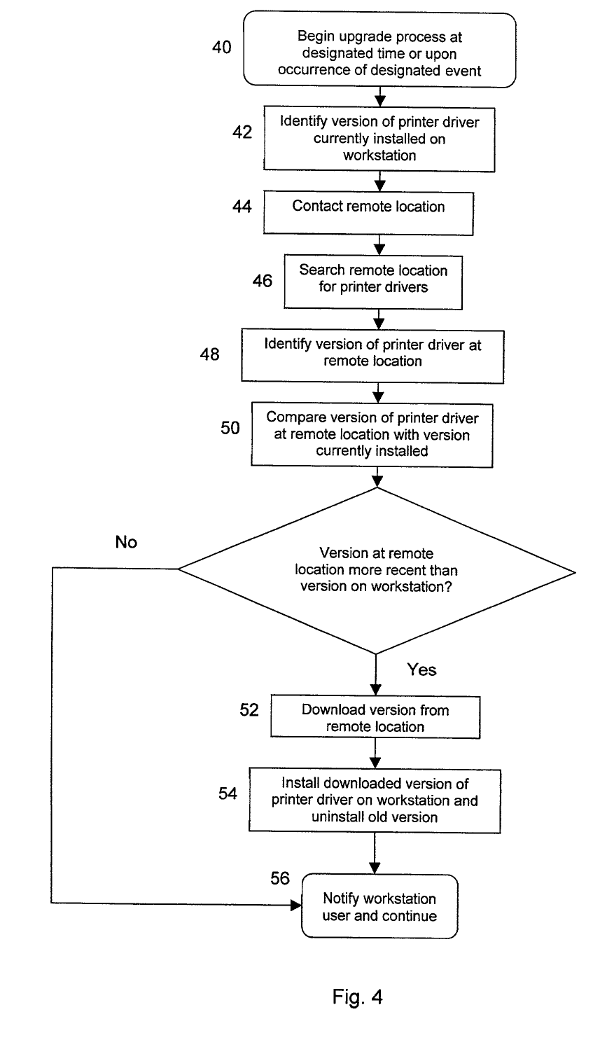

An embodiment of an update process for the present application is illustrated in FIG. 4. At a designated time or at the occurrence of a designated event, the program subroutine begins the update process 40 by initially determining the version of the printer driver currently installed on the workstation 42. This is done by reading the version information, which is stored in the initialization file (“II file”) of the driver. The driver will then contact a network location that is remote from the workstation on which an updated version of each printer driver may be stored 44. This update location to be searched by can be programmed into the driver. Further, a hierarchy of update locations can be programmed so that the driver will contact each successive update location until it exhausts all locations or finds a more current version of itself. The location of an updated driver may be any external location accessible to the workstation or its server such as a designated web server 24 on the Internet 20 (FIGS. 1, 2) or the static memory 28 of a server 18 on a LAN (FIG. 3). In a LAN environment, an advantage of having updated printer drivers stored on a network server is that a system administrator is able to control which versions of printer drivers are available to the workstation users.

After contacting the update location, the driver searches 46 for any printer drivers at this location. If the driver finds one or more printer drivers, it then identifies the versions of the new drivers by querying the new drivers and reading from their initialization file to determine their tagged information version control data 48. The driver then compares itself with the new driver to determine whether the new driver is a more current of itself (i.e. a more current version of a printer driver for the same model printer, the same operating system, etc.) 50. If so, the new driver will be downloaded to the workstation 52. The old driver is then uninstalled and the new driver is installed automatically without further user intervention 54. The user is then notified of the update 56. If multiple printer drivers are installed on the workstation because, for example, the workstation is attached to multiple printers, then each printer driver will perform the process. Each driver will only search for and download more current versions of printer drivers for the same printer and the same operating system.

It should be understood that the level of automation of the update process may be modified by the user. Thus, the driver can be instructed to ask for user verification or permission before none, some or all of the steps outlined in FIG. 4 are performed.

Although a user will have the option to instruct the update application to delete the old printer driver upon the successful installation of the new printer driver, this is not always desirable. For example, the new version of a particular printer driver might contain a bug or some other irregularity that prevents it from functioning correctly. In this instance, it is preferable to have the previous version of the printer driver still available so that it may be reinstalled to prevent a disruption in print services. Therefore, the old printer driver may be stored in the workstation's memory after it is uninstalled.

The workstation user can manipulate the level of automation to be exhibited by the driver in conducting the update process. Thus, the driver may be set to ask permission from the workstation user prior to beginning the update process, prior to downloading a new version of the printer driver or prior to installing a new version of the printer driver. Alternatively, the driver can be programmed to simply notify the user after an update is completed. FIG. 4 depicts an update process with a high level of automation in which the driver only notifies the user after a download and install of an updated driver has been completed.

In an alternate embodiment, the automatic upgrade feature is not part of the printer driver, but is instead part of a separate install/upgrade application located on the workstation (not shown). In this type of configuration, the single application can automatically upgrade all printer drivers that may be on a single workstation. The update process is the same, with the upgrade application first determining the versions of all printer drivers currently installed and then searching for and downloading any more current versions of those printer drivers. The upgrade feature can be programmed to search the same or different upgrade locations for each printer driver on the workstation.

The invention has been described with reference to an illustrative embodiment. Obviously, modifications and alterations will occur to others upon a reading and understanding of the preceding detailed description. It is intended that the invention be construed as including all such alterations and modifications insofar as they come within the scope of the appended claims or the equivalents thereof.

What is claimed is:

1. A method for automatically updating a printer driver on a computer comprising the steps of:
(A) contacting a remote network location;
(B) comparing a first version of the printer driver installed on the computer with a second version stored at the remote network location;
(C) downloading and installing the printer driver from the remote location onto the computer if it is a more recent version of the printer driver than one currently installed on the computer; and
(D) uninstalling the version of the printer driver previously stored on the computer.

2. A method according to claim 1 in which the comparing step includes querying the second version of the driver by reading from the initialization file of the second version to determine its version.

3. A method according to claim 1 in which each step is performed at a designated time or upon the occurrence of a designated event without prompting by the computer user.

4. A method according to claim 1 in which the second version is stored at a location a system administrator can control which versions of printer drivers are stored there.

5. A method according to claim 1 in which the level of user interaction required in the updating process can be varied.

6. A method according to claim 1 in which the steps are performed without cessation or interruption of the computer system or its programs during the execution of the steps.

7. A computer system containing a software module that allows a printer driver stored on the computer system to be automatically updated, in which the software module
(A) contacts a specified remote network location at which a second version of the printer driver is stored;
(B) determines the version of a printer driver stored at the remote location;
(C) compares the installed version of the printer driver with the version stored at the remote location;
(D) downloads and installs on the computer system the version of the printer driver stored at the remote location if it is a newer version than the version currently installed on the computer system; and
(E) uninstalls the previous version of the printer driver from the computer system.

8. The computer system of claim 7 wherein the software module is a program subroutine of the printer driver.

9. The computer system of claim 7 wherein the new printer driver can be downloaded and installed without cessation or interruption of the computer system or its programs during its execution.

10. The computer system of claim 7 wherein the software module is part of an install/upgrade application distinct from the printer driver.
